(19) United States
(12) Patent Application Publication
(10) Pub. No.: US 2026/0192331 A1
(43) Pub. Date: Jul. 9, 2026

(54) HYDROPHOBIC AND OLEOPHOBIC FILM LAYER, AND METHOD FOR PREPARING THE SAME

(71) Applicant: JIANGSU FAVORED NANOTECHNOLOGY CO., LTD., Wuxi (CN)

(72) Inventor: Jian ZONG, Wuxi (CN)

(73) Assignee: JIANGSU FAVORED NANOTECHNOLOGY CO., LTD., Wuxi (CN)

(21) Appl. No.: 19/132,444

(22) PCT Filed: Nov. 2, 2023
(86) PCT No.: PCT/CN2023/129204

§ 371 Date: May 23, 2025

(30) Foreign Application Priority Data
Nov. 25, 2022 (CN) 202211490705.7

(51) Int. Cl. B05D 5/08; B05D 1/00; B05D 3/04; B05D 3/14

(52) U.S. Cl. CPC B05D 5/083; B05D 1/62; B05D 3/0406; B05D 3/0493; B05D 3/142; B05D 2203/30; B05D 2401/10; B05D 2401/33; B05D 2506/10

(57) ABSTRACT

The present disclosure provides a hydrophobic and oleophobic film layer and a method for preparing the hydrophobic and oleophobic film layer. The hydrophobic and oleophobic film layer is prepared by plasma chemical vapor deposition from a perfluoropolyether monomer containing acrylate group(s) and a monomer containing two or mor carbon-carbon unsaturated bonds.

### CROSS-REFERENCE TO RELATED APPLICATIONS

This application claims the priority to Chinese Patent Application No. 202211490705.7, filed on Nov. 25, 2022, and entitled “HYDROPHOBIC AND OLEOPHOBIC FILM LAYER, AND PREPARATION METHOD THEREFOR”, the contents of which are incorporated herein by reference in their entirety.

### TECHNICAL FIELD

The present disclosure generally relates to surface modification field, and more particularly, to a hydrophobic and oleophobic film layer and a method for preparing the hydrophobic and oleophobic film layer.

### BACKGROUND

Hydrophobic and oleophobic film layers can be applied to substrates for is surface self-cleaning, anti-fouling and corrosion protection. Preparation of oleophobic surfaces is more challenging than preparation of hydrophobic surfaces because the surface tension of water (72 mN/m) is much higher than that of oil (25-40 mN/m). Oil can diffuse on almost any non-fluorinated substrate. Only when the surface energy of the substrate or coating is lower than the surface energy of the oil, the substrate or coating exhibits varying degrees of oleophobicity. Therefore, fluorocarbon groups (—CF₂ and —CF₃) may be used for preparing oleophobic surfaces, as they reduce the material's surface tension more effectively than hydrocarbons.

Long-chain perfluoroalkyl compounds (CₙF₂ₙ₊₁—R, n≥7, LCPFAs) are widely used in the preparation of hydrophobic and oleophobic surfaces. However, due to the bioaccumulation and toxicity to the environment, humans and wildlife, as well as the resistance to degradation in nature, LCPFAs have been phased out of production and applications, and the EU POPs regulation mandates a ban on the use of Perfluorooctanoic Acid (PFOA) and Perfluorooctane Sulfonic Acid (PFOS) and their derivatives.

Perfluoropolyethers (PFPEs) can serve as alternatives to long-chain perfluoroalkyl substances, with perfluorocarbon chains separated by oxygen atoms in the main chain, no long fluorocarbon alkyl chain, and no bioaccumulative toxicity. Additionally, their surface energy can be as low as 10-14 mN/m. Therefore, hydrophobic and oleophobic film layers can be prepared based on the modification of perfluoropolyether chain segments.

However, although the film layer prepared by perfluoropolyether modification has hydrophobicity and oleophobicity, due to the good flexibility of the perfluoropolyether chain segments, the perfluoropolyether chains on the surface of the film layer are prone to rearrangement when contacting with water and other polar molecules, leading to the polar ether bonds being exposed at the air interface, which leads to a decrease in hydrophobicity of the film layer and results in unstable hydrophobic performance in applications.

Therefore, there is a need to prepare a film layer with good and stable hydrophobic and oleophobic properties.

### SUMMARY

Embodiments of the present disclosure provide a hydrophobic and oleophobic film layer, the hydrophobic and oleophobic film layer is a plasma polymerization coating formed by contacting a substrate with a plasma of a monomer α and a plasma of a monomer β, and the monomer α has a structure of formula (1),

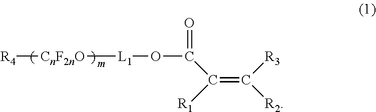

In formula (1), R₁, R₂ and R₃ are respectively and independently selected from a C₁-C₄ hydrocarbon group or a hydrogen atom; R₄ is selected from a C₁-C₄ perfluorinated alkyl group or a fluorine atom; L₁ is a linking group; m is an integer greater than or equal to 1; and each n in the m number of repeating units is respectively and independently selected from an integer greater than or equal to 1. The monomer β contains two or more carbon-carbon unsaturated bonds.

According to some embodiments, the carbon-carbon unsaturated bond of the monomer β has a structure of formula (2),

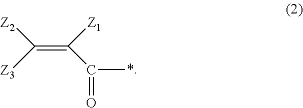

In formula (2), Z₁, Z₂ and Z₃ are respectively and independently selected from a hydrogen atom or a C₁-C₄ alkyl group.

According to some embodiments, the monomer β has a structure of formula (3),

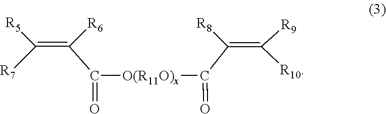

In formula (3), R₅, R₆, R₇, R₈, R₉, and R₁₀ are respectively and independently selected from a hydrogen atom or a C₁-C₄ alkyl group; R₁₁ is a C₂-C₁₀ alkylene group or a substituted C₂-C₁₀ alkylene group; x is an integer ranging from 1 to 10; and a substituent of the substituted C₂-C₁₀ alkylene group is a C₁-C₄ alkyl group or a C₁-C₄ hydroxyalkyl group.

According to some embodiments, the R₅, R₆, R₇, R₈, R₉, and R₁₀ are respectively and independently selected from a hydrogen atom or a methyl group.

According to some embodiments, the monomer β includes at least one is selected from a group consisting of: ethylene glycol dimethacrylate, ethylene glycol diacrylate, diethylene glycol dimethacrylate, diethylene glycol diacrylate, triethylene glycol dimethacrylate, triethylene glycol diacrylate, tetraethylene glycol dimethacrylate, tetraethylene glycol diacrylate, 1,3-butanediol dimethacrylate, 1,4-butanediol dimethacrylate, 1,4-butanediol diacrylate, neopentyl glycol dimethacrylate, neopentyl glycol diacrylate, 1,6-hexanediol dimethacrylate, 1,6-hexanediol diacrylate, polyethylene glycol dimethacrylate, polyethylene glycol diacrylate, polypropylene glycol dimethacrylate, polypropylene glycol diacrylate, 1,5-pentanediol diacrylate, dipropylene glycol diacrylate, and tripropylene glycol diacrylate.

According to some embodiments, the monomer β has a structure of formula (4),

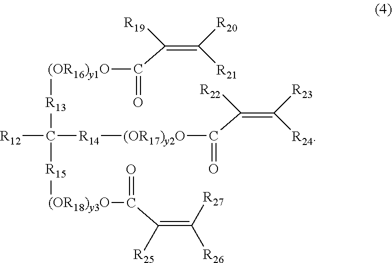

In formula (4), R₁₂ is a C₁-C₁₀ alkyl group or a hydroxyl-substituted C₁-C₁₀ alkyl group, R₁₃, R₁₄ and R₁₅ are respectively and independently selected from a C₁-C₁₀ alkylene group, R₁₆, R₁₇ and R₁₈ are respectively and independently selected from a C₂-C₁₀ alkylene group, R₁₉, R₂₀, R₂₁, R₂₂, R₂₃, R₂₄, R₂₅, R₂₆ and R₂₇ are respectively and independently selected from a hydrogen atom or a C₁-C₄ alkyl group, and y1, y2 and y3 are respectively and independently selected from an integer ranging from 0 to 10.

According to some embodiments, in formula (4), the R₁₂ is a C₁-C₄ alkyl group or a C₁-C₄ hydroxyalkyl group, the R₁₃, R₁₄ and R₁₅ are respectively and independently selected from a C₁-C₄ alkylene group, the R₁₆, R₁₇ and R₁₈ are respectively and independently selected from a C₂-C₄ alkylene group, the R₁₉, R₂₀, R₂₁, R₂₂, R₂₃, R₂₄, R₂₅, R₂₆ and R₂₇ are respectively and independently selected from a hydrogen atom or a methyl group, and the y1, y2 and y3 are respectively and independently selected from an integer ranging from 0 to 2.

According to some embodiments, the monomer β includes at least one selected from a group consisting of: trimethylolpropane trimethacrylate, trimethylolpropane triacrylate, pentaerythritol triacrylate, ethoxylated trimethylolpropane triacrylate, and propoxylated trimethylolpropane triacrylate.

According to some embodiments, the monomer β includes at least one selected from a group consisting of: pentaerythritol tetraacrylate, dipentaerythritol pentaacrylate, dipentaerythritol hexaacrylate, triallyl cyanurate, triallylamine, divinylbenzene, diethylene glycol divinyl ether, triethylene glycol divinyl ether, 1,4-butanediol divinyl ether, pentaerythritol triallyl ether, 2,6-dimethyl-2,4,6-octatriene, 1,2,4-trivinylcyclohexane, and 1,4-cyclohexanedimethanol divinyl ether.

According to some embodiments, the monomer β includes at least one selected from a group consisting of: diethylene glycol diacrylate, trimethylolpropane triacrylate, and 1,6-hexanediol diacrylate.

According to some embodiments, a molar ratio of the monomer α to the monomer β ranges from 0.5:9.5 to 9.5:0.5.

According to some embodiments, the molar ratio of the monomer α to the monomer β ranges from 5:5 to 9.5:0.5.

According to some embodiments, in formula (1), the R₁, R₂ and R₃ are respectively and independently selected from a methyl group or a hydrogen atom.

According to some embodiments, in formula (1), the R₁ is a methyl group, and the R₂ and R₃ are hydrogen atoms.

According to some embodiments, a weight-average molecular weight of the monomer α is greater than or equal to 1000.

According to some embodiments, in formula (1), the L₁ is selected from a substituted C₁-C₄ alkylene group or an unsubstituted C₁-C₄ alkylene group.

According to some embodiments, a substituent of the substituted C₁-C₄ alkylene group includes one or more selected from a group consisting of: alkyl, cycloalkyl, alkenyl, alkynyl, aryl, heteroaryl, heterocyclic group, carboxyl, carboxylate ion, carboxylic ester group, carbamate group, alkoxy, ketone group, aldehyde group, amine group, amide group, hydroxyl, nitrile group, nitroso group, and halogen.

According to some embodiments, in formula (1), the L₁ is a perfluorinated alkylene group.

According to some embodiments, the monomer α has a structure of formula (5),

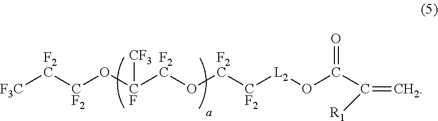

In formula (5), a is an integer greater than or equal to 1; and L₂ is selected from a connecting bond, a substituted methylene group or an unsubstituted methylene group, or a substituted ethylene group or an unsubstituted ethylene group.

According to some embodiments, the monomer α has a structure of formula (6),

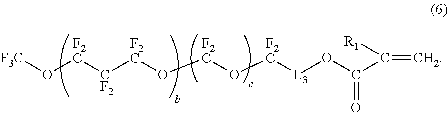

In formula (6), b is an integer greater than or equal to 1, c is an integer greater than or equal to 1, and L₃ is selected from a connecting bond, or a substituted C₁-C₃ alkylene group or an unsubstituted C₁-C₃ alkylene group.

According to some embodiments, the monomer α has a structure of formula (7),

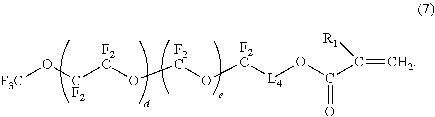

In formula (7), d is an integer greater than or equal to 1, e is an integer greater than or equal to 1, and L₄ is selected from a connecting bond, or a substituted C₁-C₃ alkylene group or an unsubstituted C₁-C₃ alkylene group.

According to some embodiments, the monomer α has a structure of formula

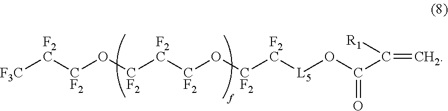

In formula (8), f is an integer greater than or equal to 1; and L₅ is selected from a connecting bond, a substituted methylene group or an unsubstituted methylene group, or a substituted ethylene group or an unsubstituted ethylene group.

According to some embodiments, a water contact angle of the hydrophobic and oleophobic film layer is greater than or equal to 95°, and an n-hexadecane contact angle of the hydrophobic and oleophobic film layer is greater than or equal to 60°.

According to some embodiments, a water contact angle of the hydrophobic and oleophobic film layer is greater than or equal to 108°, and an n-hexadecane contact angle of the hydrophobic and oleophobic film layer is greater than or equal to 65°.

Embodiments of the present disclosure also provide a device, and at least a part of a surface of the device is provided with the hydrophobic and oleophobic film layer according to any one of aforementioned embodiments.

Embodiments of the present disclosure also provide a method for preparing the hydrophobic and oleophobic film layer according to any one of aforementioned embodiments. The method includes: placing a substrate in a plasma reaction chamber; and vaporizing and then introducing the monomer α and the monomer β into the plasma reaction chamber, turning on a plasma discharge, and forming the hydrophobic and oleophobic film layer on a surface of the substrate from the plasma of monomer α and the plasma of monomer β through chemical vapor deposition.

According to some embodiments, vaporizing and then introducing the monomer α and the monomer β into the plasma reaction chamber includes: dissolving and then adding the monomer α, a fluorine-containing solvent and a polymerization inhibitor into a monomer tank 1, and adding the monomer β into a monomer tank 2; and heating the monomer tank 1 and the monomer tank 2 to vaporize the monomer α and the monomer β and then introducing the monomer α and the monomer β into the plasma reaction chamber.

According to some embodiments, a flow rate of the gas introduced from the monomer tank 1 into the plasma reaction chamber ranges from 10 μL/min to 2000 μL/min, and a flow rate of the gas introduced from the monomer tank 2 into the plasma reaction chamber ranges from 10 μL/min to 2000 μL/min.

According to some embodiments, a mass of the polymerization inhibitor ranges from 0.1% to 1% of a mass of the monomer α.

According to some embodiments, a polymerization inhibitor is also added into the monomer tank 2, and a mass of the polymerization inhibitor ranges from 0.1% to 1% of the mass of the monomer β.

According to some embodiments, a weight ratio of the monomer α to the fluorine-containing solvent ranges from 1:9 to 9:1.

According to some embodiments, the fluorine-containing solvent is a fluorocarbon solvent, and the fluorocarbon solvent includes one or more selected from a group consisting of: methyl perfluorobutyl ether, ethyl perfluorobutyl ether, 3-methoxyperfluorohexane, perfluorobutyl ethyl propyl ether, perfluoropolyether oil, hexafluoropropylene oxide dimer, hexafluoropropylene oxide trimer, perfluorotriethylamine, perfluorotripropylamine, perfluorotributylamine, 3M electronic fluorinated liquid 7100, 3M electronic fluorinated liquid 7200, 3M electronic fluorinated liquid 7300, 3M electronic fluorinated liquid 7500, and 3M electronic fluorinated liquid 7700.

According to some embodiments, the polymerization inhibitor includes one or more selected from a group consisting of: hydroquinone, p-benzoquinone, methyl hydroquinone, p-hydroxyanisole, 2-tert-butylhydroquinone, 2,5-di-tert-butylhydroquinone, and 2,6-di-tert-butyl-p-cresol.

According to some embodiments, the plasma discharge is a continuous discharge, a discharge power ranges from 10 W to 300 W, and a discharge duration time ranges from 60 s to 36000 s.

According to some embodiments, the plasma discharge is a pulse discharge, a discharge power ranges from 10 W to 400 W, a pulse duty cycle ranges from 0.1% to 80%, a pulse frequency ranges from 10 Hz to 500 Hz, and a discharge duration time ranges from 200 s to 36000 s.

According to some embodiments, the method further includes: before the chemical vapor deposition, vacuumizing to get a vacuum degree range from 10 mTorr to 200 mTorr, introducing one or more gases selected from a group consisting of He, Ar, and O₂, and turning on a plasma discharge to pretreat the substrate.

According to some embodiments, the plasma discharge includes: electrodeless discharge, single-electrode discharge, dual-electrode discharge, or multi-electrode discharge.

Embodiments of the present disclosure may provide following advantages over conventional technology.

In embodiments of the present disclosure, the hydrophobic and oleophobic film layer is prepared by plasma chemical vapor deposition from a perfluoropolyether monomer containing (meth)acrylate group(s) and a monomer containing two or more carbon-carbon unsaturated bonds, a water contact angle of the hydrophobic and oleophobic film layer is greater than or equal to 95°, and an n-hexadecane contact angle of the hydrophobic and oleophobic film layer is greater than or equal to 60°. In embodiments of the present disclosure, a water contact angle of the hydrophobic and oleophobic film layer is greater than or equal to 108°, and an n-hexadecane contact angle of the hydrophobic and oleophobic film layer is greater than or equal to 65°.

In embodiments of the present disclosure, a water contact angle of the hydrophobic and oleophobic film layer remains stable and decreases at a slow rate at 85° C. temperature and 85% Relative Humidity (RH). Therefore, the hydrophobic and oleophobic film layer has good hydrophobic and oleophobic stability.

### BRIEF DESCRIPTION OF THE DRAWINGS

FIG. 1 illustrates a graph showing Double 85 Test results for Embodiment 1, Embodiment 2, and Comparative Embodiment 1 in Detailed Description of the present disclosure; and

FIG. 2 illustrates a graph showing Double 85 Test results for Embodiment 3 to Embodiment 7 in Detailed Description of the present disclosure.

### DETAILED DESCRIPTION

Embodiments of the present disclosure are described in detail below, and the description is exemplary, is intended only for the purpose of explaining the present disclosure, and should not to be construed as a limitation of the present disclosure.

In order to realize hydrophobic and oleophobic performance of a surface of a substrate, a device and the like, with hydrophobic and oleophobic stability and without creating environmental problems, embodiments of the present disclosure provide a hydrophobic and oleophobic film layer, and the hydrophobic and oleophobic film layer is a plasma polymerization coating formed by contacting the substrate with a plasma of a monomer α and a plasma of a monomer β. The monomer α has a structure of formula (1),

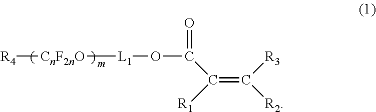

In formula (1), R₁, R₂ and R₃ are respectively and independently selected from a C₁-C₄ hydrocarbon group or a hydrogen atom; R₄ is selected from a C₁-C₄ perfluorinated alkyl group or a fluorine atom; L₁ is a linking group; m is an integer greater than or equal to 1; and each n in the m number of repeating units is respectively and independently selected from an integer greater than or equal to 1. The monomer β contains two or more carbon-carbon unsaturated bonds.

The inventor has found that the hydrophobic and oleophobic film layer formed by plasma chemical vapor deposition from the monomer α having a structure of formula (1) and the monomer β containing two or more carbon-carbon unsaturated bonds has excellent hydrophobic and oleophobic effect and stability. The plasma polymerization of the monomer β with the monomer α increases the cross-linking density of the polymer, thereby limiting the rearrangement of perfluoropolyether chains and improving the hydrophobic stability.

According to some embodiments of the present disclosure, the carbon-carbon unsaturated bond of the monomer β has a structure of formula (2),

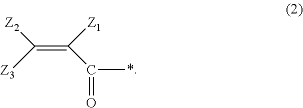

In formula (2), Z₁, Z₂ and Z₃ are respectively and independently selected from a hydrogen atom or a C₁-C₄ alkyl group.

According to some embodiments of the present disclosure, in formula (2), the Z₁ is selected from a hydrogen atom or a methyl group, and Z₂ and Z₃ are hydrogen atoms.

According to some embodiments of the present disclosure, the monomer has a structure of formula (3),

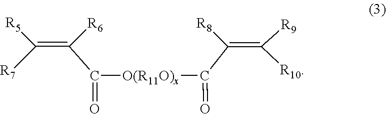

In formula (3), R₅, R₆, R₇, R₈, R₉, and R₁₀ are respectively and independently selected from a hydrogen atom or a C₁-C₄ alkyl group; R₁ is a C₂-C₁₀ alkylene group or a substituted C₂-C₁₀ alkylene group; a substituent of the substituted C₂-C₁₀ alkylene group is a C₁-C₄ alkyl group or a C₁-C₄ hydroxyalkyl group; and x is an integer ranging from 1 to 10.

According to some embodiments of the present disclosure, in formula (3), the R₅, R₆, R₇, R₈, R₉, and R₁₀ are respectively and independently selected from a hydrogen atom or a methyl group. According to some embodiments, the R₆ and R₈ are respectively and independently selected from a hydrogen atom or a methyl group, and the R₅, R₇, R₉, and R₁₀ are hydrogen atoms.

According to some embodiments of the present disclosure, in formula (3), the R₅, R₆, R₇, R₈, R₉, and R₁₀ are hydrogen atoms, R₁₁ is an ethylidene, and x is 2.

According to some embodiments of the present disclosure, in formula (3), the Rₜ, R₆, R₇, R₈, R₉, and R₁₀ are hydrogen atoms, R₁₂ is a hexylidene, and x is 1.

According to some embodiments of the present disclosure, the monomer β includes at least one selected from a group consisting of: ethylene glycol dimethacrylate, ethylene glycol diacrylate, diethylene glycol dimethacrylate, diethylene glycol diacrylate, triethylene glycol dimethacrylate, triethylene glycol diacrylate, tetraethylene glycol dimethacrylate, tetraethylene glycol diacrylate, 1,3-butanediol dimethacrylate, 1,4-butanediol dimethacrylate, 1,4-butanediol diacrylate, neopentyl glycol dimethacrylate, neopentyl glycol diacrylate, 1,6-hexanediol dimethacrylate, 1,6-hexanediol diacrylate, polyethylene glycol dimethacrylate, polyethylene glycol diacrylate, polypropylene glycol dimethacrylate, polypropylene glycol diacrylate, 1,5-pentanediol diacrylate, dipropylene glycol diacrylate, and tripropylene glycol diacrylate.

According to some embodiments of the present disclosure, the monomer has a structure of formula (4),

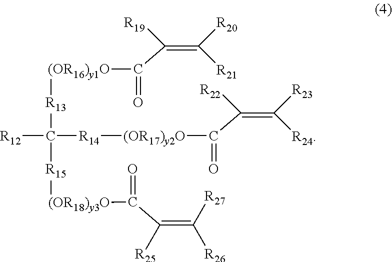

In formula (4), R₁₂ is a C₁-C₁₀ alkyl group or a hydroxyl-substituted C₁-C₁₀ alkyl group, R₁₃, R₁₄ and R₁₅ are respectively and independently selected from a C₁-C₁₀ alkylene group, R₁₆, R₁₇ and R₁₈ are respectively and independently selected from a C₂-C₁₀ alkylene group, R₁₉, R₂₀, R₂₁, R₂₂, R₂₃, R₂₄, R₂₅, R₂₆ and R₂₇ are respectively and independently selected from a hydrogen atom or a C₁-C₄ alkyl group, and y1, y2 and y3 are respectively and independently selected from an integer ranging from 0 to 10.

According to some embodiments of the present disclosure, in formula (4), the R₁₂ is a C₁-C₄ alkyl group or a C₁-C₄ hydroxyalkyl group, the R₁₀, R₁₄ and R₁₅ are respectively and independently selected from a C₁-C₄ alkylene group, the R₁₆, R₁₇ and R₁₈ are respectively and independently selected from a C₂-C₄ alkylene group, the R₁₉, R₂₀, R₂₁, R₂₂, R₂₃, R₂₄, R₂₅, R₂₆ and R₂₇ are respectively and independently selected from a hydrogen atom or a methyl group, and the y1, y2 and y3 are respectively and independently selected from an integer ranging from 0 to 2.

According to some embodiments of the present disclosure, the R₁₂ is an ethyl group, the R₁₉, R₂₀, R₂₁, R₂₂, R₂₃, R₂₄, R₂₅, R₂₆ and R₂₇ are hydrogen atoms, the R₁₃, R₁₄ and R₁₅ are methyl groups, and y1, y2 and y3 are 0.

According to some embodiments of the present disclosure, the monomer includes at least one selected from a group consisting of: trimethylolpropane trimethacrylate, trimethylolpropane triacrylate, pentaerythritol triacrylate, ethoxylated trimethylolpropane triacrylate, and propoxylated trimethylolpropane triacrylate.

According to some embodiments of the present disclosure, the monomer β includes at least one selected from a group consisting of: pentaerythritol tetraacrylate, dipentaerythritol pentaacrylate, dipentaerythritol hexaacrylate, triallyl cyanurate, triallylamine, divinylbenzene, diethylene glycol divinyl ether, triethylene glycol divinyl ether, 1,4-butanediol divinyl ether, pentaerythritol triallyl ether, 2,6-dimethyl-2,4,6-octatriene, 1,2,4-trivinylcyclohexane, and 1,4-cyclohexanedimethanol divinyl ether.

According to some embodiments of the present disclosure, the monomer β includes at least one selected from a group consisting of: diethylene glycol diacrylate, trimethylolpropane triacrylate, and 1,6-hexanediol diacrylate.

According to some embodiments of the present disclosure, a molar ratio of the monomer α to the monomer β relates to the hydrophobic performance, the oleophobic performance, and the hydrophobic and oleophobic stability of the hydrophobic and oleophobic film layer. Therefore, the molar ratio of the monomer α to the monomer β can be set based on the requirements of the water contact angle and the oil contact angle in practical applications. According to some embodiments, the molar ratio of the monomer α to the monomer β ranges from 0.5:9.5 to 9.5:0.5, being such as 0.5:9.5, 3:7, 1:9, 5:5, 7:3, 9:1, 9.5:0.5, etc.

According to some embodiments of the present disclosure, the molar ratio of the monomer α to the monomer β ranges from 3:7 to 9.5:0.5.

According to some embodiments of the present disclosure, the molar ratio of the monomer α to the monomer β ranges from 5:5 to 9.5:0.5.

According to some embodiments of the present disclosure, the monomer α has the structure of formula (1); and in formula (1), the R₁, R₂, and R₃ are respectively and independently selected from a methyl group or a hydrogen atom. According to some embodiments, in formula (1), the R₁ is a methyl group, and the R₂ and R₃ are hydrogen atoms.

According to some embodiments of the present disclosure, in order to ensure a good crosslinking density, a weight-average molecular weight of the monomer α is greater than or equal to 1000, being such as 1000, 2000, 3000, 4000, 5000, etc.

According to some embodiments of the present disclosure, in formula (1), the L₁ is selected from a substituted C₁-C₄ alkylene group or an unsubstituted C₁-C₄ alkylene group.

According to some embodiments of the present disclosure, a substituent of the substituted C₁-C₄ alkylene group includes one or more selected from a group consisting of: alkyl, cycloalkyl, alkenyl, alkynyl, aryl, heteroaryl, heterocyclic group, carboxyl, carboxylate ion, carboxylic ester group, carbamate group, alkoxy, ketone group, aldehyde group, amine group, amide group, hydroxyl, nitrile group, nitroso group, and halogen. According to some embodiments, the L₁ is a perfluorinated alkylene group with a straight chain or branched chain(s). According to some embodiments, the L₁ is a perfluorinated alkylene group.

According to some embodiments of the present disclosure, the perfluoropolyether chain segment includes a K-type structure, and the monomer α has a structure of formula (5),

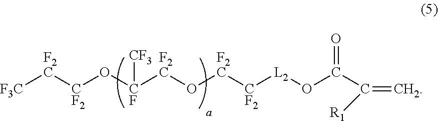

In formula (5), a is an integer greater than or equal to 1; and L₂ is selected from a connecting bond, a substituted methylene group or an unsubstituted methylene group, or a substituted ethylene group or an unsubstituted ethylene group. The substituent may include one or more selected from a group consisting of: alkyl, cycloalkyl, alkenyl, alkynyl, aryl, heteroaryl, heterocyclic group, carboxyl, carboxylate ion, carboxylic ester group, carbamate group, alkoxy, ketone group, aldehyde group, amine group, amide group, hydroxyl, nitrile group, nitroso group, and halogen.

According to some embodiments of the present disclosure, the perfluoropolyether chain segment includes a Y-type structure, and the monomer α has a structure of formula (6),

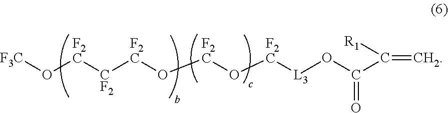

In formula (6), b is an integer greater than or equal to 1, c is an integer greater than or equal to 1, and L₃ is selected from a connecting bond, or a substituted C₁-C₃ alkylene group or an unsubstituted C₁-C₃ alkylene group. The substituent may include one or more selected from a group consisting of: alkyl, cycloalkyl, alkenyl, alkynyl, aryl, heteroaryl, heterocyclic group, carboxyl, carboxylate ion, carboxylic ester group, carbamate group, alkoxy, ketone group, aldehyde group, amine group, amide group, hydroxyl, nitrile group, nitroso group, and halogen.

According to some embodiments of the present disclosure, the perfluoropolyether chain segment includes a Z-type structure, and the monomer α has a structure of formula (7),

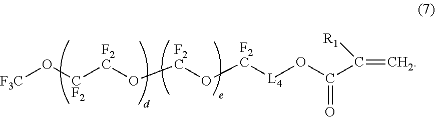

In formula (7), d is an integer greater than or equal to 1, e is an integer greater than or equal to 1, and L₄ is selected from a connecting bond, or a substituted C₁-C₃ alkylene group or an unsubstituted C₁-C₃ alkylene group. The substituent may include one or more selected from a group consisting of: alkyl, cycloalkyl, alkenyl, alkynyl, aryl, heteroaryl, heterocyclic group, carboxyl, carboxylate ion, carboxylic ester group, carbamate group, alkoxy, ketone group, aldehyde group, amine group, amide group, hydroxyl, nitrile group, nitroso group, and halogen.

According to some embodiments of the present disclosure, the perfluoropolyether chain segment includes a D-type structure, and the monomer α has a structure of formula (8),

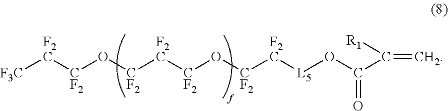

In formula (8), f is an integer greater than or equal to 1; and L₅ is selected from a connecting bond, a substituted methylene group or an unsubstituted methylene group, or a substituted ethylene group or an unsubstituted ethylene group. The substituent may include one or more selected from a group consisting of: alkyl, cycloalkyl, alkenyl, alkynyl, aryl, heteroaryl, heterocyclic group, carboxyl, carboxylate ion, carboxylic ester group, carbamate group, alkoxy, ketone group, aldehyde group, amine group, amide group, hydroxyl, nitrile group, nitroso group, and halogen.

According to some embodiments of the present disclosure, in formula (5) to formula (8), R₁ is a methyl group.

According to some embodiments of the present disclosure, a water contact angle of the hydrophobic and oleophobic film layer is greater than or equal to 95°, and an n-hexadecane contact angle of the hydrophobic and oleophobic film layer is greater than or equal to 60°.

According to some embodiments of the present disclosure, a water contact angle of the hydrophobic and oleophobic film layer is greater than or equal to 108°, and an n-hexadecane contact angle of the hydrophobic and oleophobic film layer is greater than or equal to 65°.

Some embodiments of the present disclosure also provide a device, and at least a part of a surface of the device is provided with any of the aforementioned hydrophobic and oleophobic film layer. According to some embodiments, the entire surface of the device is provided with the hydrophobic and oleophobic film layer for achieving a hydrophobic and oleophobic effect stably over a long period of time.

According to some embodiments of the present disclosure, the device includes an electrical assembly, an optical instrument, an electronic or electrical component, and the like.

Some embodiments of the present disclosure also provide a method for preparing any of the aforementioned hydrophobic and oleophobic film layer. The method includes: placing a substrate in a plasma reaction chamber; and vaporizing and then introducing the monomer α and the monomer β into the plasma reaction chamber, turning on a plasma discharge, and forming the hydrophobic and oleophobic film layer on a surface of the substrate from the plasma of monomer α and the plasma of monomer β through chemical vapor deposition.

According to some embodiments of the present disclosure, vaporizing and then introducing the monomer α and the monomer β into the plasma reaction chamber includes: dissolving and then adding the monomer α, a fluorine-containing solvent and a polymerization inhibitor into a monomer tank 1, and adding the monomer β into a monomer tank 2; and heating the monomer tank 1 and the monomer tank 2 to vaporize the monomer α and the monomer β and then introducing the monomer α and the monomer β into the plasma reaction chamber.

According to some embodiments of the present disclosure, a flow rate ratio of the monomer α to the monomer β for entering the plasma reaction chamber during the coating time is controlled to control a molar amount of the monomer α relative to that of the monomer β, a molar ratio of the monomer α to the monomer β relates to the hydrophobic performance, the oleophobic performance, and the hydrophobic and oleophobic stability of the hydrophobic and oleophobic film layer, and the flow rate of the monomer α and the monomer β can be set based on the application needs of the film layer. A ratio of the flow rate of the gas introduced from the monomer tank 1 into the plasma reaction chamber to the flow rate of the gas introduced from the monomer tank 2 into the plasma reaction chamber ranges from 0.5:9.5 to 9.5:0.5, being such as 0.5:9.5, 3:7, 1:9, 5:5, 7:3, 9:1, 9.5:0.5, etc.

According to some embodiments of the present disclosure, the ratio of the flow rate of the gas introduced from the monomer tank 1 into the plasma reaction chamber to the flow rate of the gas introduced from the monomer tank 2 into the plasma reaction chamber ranges from 3:7 to 9.5:0.5. According to some embodiments, the ratio of the flow rate of the gas introduced from the monomer tank 1 into the plasma reaction chamber to the flow rate of the gas introduced from the monomer tank 2 into the plasma reaction chamber ranges from 5:5 to 9.5:0.5.

According to some embodiments of the present disclosure, the flow rate of the gas introduced from the monomer tank 1 into the plasma reaction chamber ranges from 10 μL/min to 2000 μL/min, being such as 10 μL/min, 15 μL/min, 30 μL/min, 90 μL/min, 100 μL/min, 120 μL/min, 150 μL/min, 180 μL/min, 210 μL/min, 270 μL/min, 285 μL/min, 300 μL/min, 500 μL/min, 1000 μL/min, 1500 μL/min, 2000 μL/min, etc. According to some embodiments, the flow rate of the gas introduced from the monomer tank 2 into the plasma reaction chamber ranges from 10 μL/min to 2000 μL/min, being such as 10 μL/min, 15 μL/min, 30 μL/min, 90 μL/min, 100 μL/min, 120 μL/min, 150 μL/min, 180 μL/min, 210 μL/min, 270 μL/min, 500 μL/min, 1000 μL/min, 1500 μL/min, 2000 μL/min, etc.

According to some embodiments of the present disclosure, since the monomer α has a relatively high molecular weight and certain viscosity, a fluorine-containing solvent is added to ensure smooth introduction of the monomer into the plasma reaction chamber. According to some embodiments, the fluorine-containing solvent is a fluorocarbon solvent. According to some embodiments, the fluorocarbon solvent includes one or more selected from a group consisting of: methyl perfluorobutyl ether, ethyl perfluorobutyl ether, 3-methoxyperfluorohexane, perfluorobutyl ethyl propyl ether, perfluoropolyether oil, hexafluoropropylene oxide dimer, hexafluoropropylene oxide trimer, perfluorotriethylamine, perfluorotripropylamine, perfluorotributylamine, 3M electronic fluorinated liquid 7100, 3M electronic fluorinated liquid 7200, 3M electronic fluorinated liquid 7300, 3M electronic fluorinated liquid 7500, and 3M electronic fluorinated liquid 7700.

According to some embodiments of the present disclosure, a weight ratio of the monomer α to the fluorine-containing solvent ranges from 1:9 to 9:1, being such as 1:9, 1:8, 1:7, 1:6, 1:5, 1:4, 1:3, 3:7, 1:2, 1:1, 2:1, 7:3, 3:1, 4:1, 5:1, 6:1, 7:1, 8:1, 9:1, etc.

According to some embodiments of the present disclosure, in order to prevent polymerization of the monomer α during heating/vaporization, a polymerization inhibitor is added to prevent polymerization and to avoid forming a polymer in the monomer tank. According to some embodiments, the polymerization inhibitor includes one or more selected from a group consisting of: hydroquinone, p-benzoquinone, methyl hydroquinone, p-hydroxyanisole, 2-tert-butylhydroquinone, 2,5-di-tert-butylhydroquinone, and 2,6-di-tert-butyl-p-cresol.

According to some embodiments of the present disclosure, a mass of the polymerization inhibitor ranges from 0.1% to 1% of a mass of the monomer α, being such as 0.1%, 0.2%, 0.3%, 0.4%, 0.5%, 0.6%, 0.7%, 0.8%, 0.9%, 1%, etc.

According to some embodiments of the present disclosure, in order to prevent polymerization of the monomer 3 during heating/vaporization, a polymerization inhibitor is also added into the monomer tank 2, and a mass of the polymerization inhibitor ranges from 0.1% to 1% of the mass of the monomer β, being such as 0.1%, 0.2%, 0.3%, 0.4%, 0.5%, 0.6%, 0.7%, 0.8%, 0.9%, 1%, etc. According to some embodiments, the polymerization inhibitor includes one or more selected from a group consisting of: hydroquinone, p-benzoquinone, methyl hydroquinone, p-hydroxyanisole, 2-tert-butylhydroquinone, 2,5-di-tert-butylhydroquinone, and 2,6-di-tert-butyl-p-cresol.

According to some embodiments of the present disclosure, the monomer β is not of a high molecular weight and is less prone to polymerization during heating/vaporization process, and the polymerization inhibitor is not needed.

According to some embodiments of the present disclosure, during the plasma polymerization process, a temperature of the reaction chamber ranges from 30° C. to 60° C., being such as 30° C., 40° C., 50° C., 55° C., 60° C., etc.

According to some embodiments of the present disclosure, the plasma discharge is a continuous discharge, and a discharge power ranges from 10 W to 300 W, being such as 10 W, 50 W, 100 W, 200 W, 300 W, etc. A discharge duration time ranges from 60 s to 36000 s, being such as 60 s, 360 s, 1200 s, 2400 s, 3600 s, 7200 s, 36000 s, etc.

According to some embodiments of the present disclosure, the plasma discharge is a pulse discharge, and the discharge power ranges from 10 W to 400 W, being such as 10 W, 50 W, 100 W, 180 W, 200 W, 250 W, 300 W, 400 W, etc. A pulse duty cycle ranges from 0.1% to 80%, being such as 0.1%, 1%, 10%, 25%, 35%, 50%, 60%, 70%, 80%, etc. A pulse frequency ranges from 10 Hz to 500 Hz, being such as 10 Hz, 100 Hz, 200 Hz, 250 Hz, 300 Hz, 500 Hz, etc. A discharge duration time ranges from 200 s to 36000 s, being such as 200 s, 360 s, 1200 s, 2400 s, 3600 s, 7200 s, 36000 s, etc.

According to some embodiments of the present disclosure, before the chemical vapor deposition, it is vacuumized to get a vacuum degree range from 10 mTorr to 200 mTorr, one or more gases selected from a group consisting of He, Ar, and O₂ are introduced, and a plasma discharge is turned on to pretreat the substrate.

According to some embodiments of the present disclosure, during pretreating the substrate, the plasma discharge is a continuous discharge, and a discharge power ranges from 50 W to 600 W, being such as 50 W, 100 W, 120 W, 200 W, 300 W, 400 W, 600 W, etc. A discharge duration time ranges from 60 s to 2400 s, being such as 60 s, 360 s, 600 s, 1200 s, 1800 s, 2400 s, etc.

According to some embodiments of the present disclosure, during pretreating the substrate, the plasma discharge is a pulse discharge, and the discharge power ranges from 10 W to 500 W, being such as 10 W, 50 W, 100 W, 180 W, 200 W, 300 W, 500 W, etc. A pulse duty cycle ranges from 0.1% to 80%, being such as 0.1%, 1%, 10%, 25%, 35%, 50%, 60%, 70%, 80%, etc. A pulse frequency ranges from 10 Hz to 500 Hz, being such as 10 Hz, 100 Hz, 200 Hz, 250 Hz, 300 Hz, 500 Hz, etc. A discharge duration time ranges from 60 s to 2400 s, being such as 60 s, 360 s, 600 s, 1200 s, 1800 s, 2400 s, etc.

According to some embodiments of the present disclosure, in the pretreatment, the plasma discharge includes: electrodeless discharge, single-electrode discharge, dual-electrode discharge, or multi-electrode discharge. According to some embodiments, the electrodeless discharge includes: radio frequency inductively coupled discharge, microwave discharge, and the like. According to some embodiments, the single-electrode discharge includes: corona discharge, plasma jet generated by unipolar discharge, and the like. According to some embodiments, the dual-electrode discharge includes: dielectric barrier discharge, radio frequency glow discharge with bare electrodes, and the like. According to some embodiments, the multi-electrode discharge includes: discharge utilizing a floating electrode as the third electrode, and the like.

According to some embodiments of the present disclosure, the method further includes post-treatment, and the post-treatment includes: after the preparation of the hydrophobic and oleophobic film layer on the surface of the substrate, introducing clean compressed air or inert gas until the plasma reaction chamber returns to normal pressure, opening the plasma reaction chamber, and taking out the substrate. According to some embodiments, an inert gas is introduced at a flow rate ranging from 5 sccm to 300 sccm.

The present disclosure is further described in the following specific embodiments.

### Embodiment

### Description of Test Method

Water contact angle of the hydrophobic and oleophobic film layer: it was tested according to GB/T 30447-2013 standard.

Oil contact angle of the hydrophobic and oleophobic film layer: the n-hexadecane contact angle of the hydrophobic and oleophobic film layer was tested by SDC-100 standard contact angle measuring instrument.

Double 85 test: the substrate with a hydrophobic-oleophobic film layer prepared on the surface was placed in an environment with 85° C. temperature and 85% relative humidity (RH), and the water contact angle and the oil contact angle of the hydrophobic and oleophobic film layer were measured at different times to evaluate the stability of the hydrophobic and oleophobic properties of the film layer.

### Embodiment 1

A Si sheet serving as a substrate was placed on a substrate holder in a plasma chamber, the chamber was vacuumized to reach a pressure of 150 mTorr, helium gas was introduced at a flow rate of 200 sccm, and a temperature of the chamber was 55° C.

A pressure in the chamber was maintained at 150 mTorr, the flow rate of helium gas was maintained at 200 sccm, and a plasma continuous discharge was turned on to pretreat the substrate. The discharge power was 300 W, and the discharge duration time was 600 s.

Thereafter, a homogeneous solution was prepared by mixing 3M electronic fluorinated liquid 7200, monofunctional perfluoropolyether (methyl)acrylate (M_{w}≈1000, SuZhou Chemwells Advanced Materials CO., LTD), and hydroquinone at a weight ratio of 7:3:0.012, and then added into monomer tank 1. Diethylene glycol diacrylate (DEGDA) and hydroquinone were dissolved at a weight ratio of 1:0.004, and then added into monomer tank 2. The monomers in monomer tank 1 and monomer tank 2 were vaporized at a vaporization temperature of 110° C., and then the gas from monomer tank 1 was introduced into the plasma chamber at a flow rate of 210 μL/min and the gas from monomer tank 2 was introduced into the plasma chamber at a flow rate of 90 μL/min (i.e., the flow rate ratio was 7:3). The pressure in the chamber was maintained at 150 mTorr, the flow rate of helium gas was maintained at 200 sccm, and a radio frequency plasma discharge was turned on to carry out plasma chemical vapor deposition on the surface of the substrate. The energy output mode of radio frequency was pulse, in which the pulse duty cycle was 50%, the pulse frequency was 300 Hz, the pulse discharge power was 250 W, and the reaction time was 3600 s.

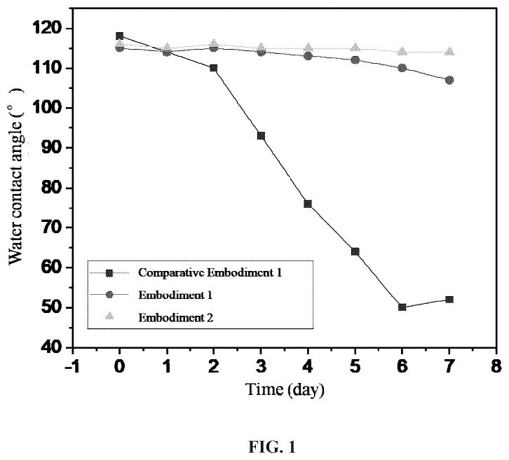

After coating, compressed air was introduced to restore the chamber to normal pressure, and the coated substrate was taken out. The water contact angle and oil contact angle were tested, and the test results are listed in the following Table 1; and the double 85 test was conducted in a high temperature and high humidity environment, and the test results are shown in FIG. 1.

### Embodiment 2

A Si sheet serving as a substrate was placed on a substrate holder in a plasma chamber, the chamber was vacuumized to reach a pressure of 150 mTorr, helium gas was introduced at a flow rate of 200 sccm, and a temperature of the chamber was 55° C.

A pressure in the chamber was maintained at 150 mTorr, the flow rate of helium gas was maintained at 200 sccm, and a plasma continuous discharge was turned on to pretreat the substrate. The discharge power was 300 W, and the discharge duration time was 600 s.

Thereafter, a homogeneous solution was prepared by mixing 3M electronic fluorinated liquid 7200, monofunctional perfluoropolyether (methyl)acrylate (M_{w}≈1000, SuZhou Chemwells Advanced Materials CO., LTD), and hydroquinone at a weight ratio of 7:3:0.012, and then added into monomer tank 1. Trimethylolpropane triacrylate (TMPTA), diethylene glycol diacrylate (DEGDA) and hydroquinone were dissolved at a weight ratio of 5:5:0.1, and then added into monomer tank 2. The monomers in monomer tank 1 and monomer tank 2 were vaporized at a vaporization temperature of 110° C., and then the gas from monomer tank 1 was introduced into the plasma chamber at a flow rate of 210 μL/min and the gas from monomer tank 2 was introduced into the plasma chamber at a flow rate of 90 μL/min (i.e., the flow rate ratio was 7:3). The pressure in the chamber was maintained at 150 mTorr, the flow rate of helium gas was maintained at 200 sccm, and a radio frequency plasma discharge was turned on to carry out plasma chemical vapor deposition on the surface of the substrate. The energy output mode of radio frequency was pulse, in which the pulse duty cycle was 50%, the pulse frequency was 300 Hz, the pulse discharge power was 250 W, and the reaction time was 3600 s.

After coating, compressed air was introduced to restore the chamber to normal pressure, and the coated substrate was taken out. The water contact angle and oil contact angle were tested, and the test results are listed in the following Table 1; and the double 85 test was conducted in a high temperature and high humidity environment, and the test results are shown in FIG. 1.

### Comparative Embodiment 1

A Si sheet serving as a substrate was placed on a substrate holder in a plasma chamber, the chamber was vacuumized to reach a pressure of 150 mTorr, helium gas was introduced at a flow rate of 200 sccm, and a temperature of the chamber was 55° C.

A pressure in the chamber was maintained at 150 mTorr, the flow rate of helium gas was maintained at 200 sccm, and a plasma continuous discharge was turned on to pretreat the substrate. The discharge power was 300 W, and the discharge duration time was 600 s.

Thereafter, a homogeneous solution was prepared by mixing 3M electronic fluorinated liquid 7200, monofunctional perfluoropolyether (methyl)acrylate (M_{w}≈1000, SuZhou Chemwells Advanced Materials CO., LTD), and hydroquinone at a weight ratio of 7:3:0.012, and then added into monomer tank 1. The monomer in monomer tank 1 was vaporized at a vaporization temperature of 110° C., and then the gas from monomer tank 1 was introduced into the plasma chamber at a flow rate of 300 μL/min. The pressure in the chamber was maintained at 150 mTorr, the flow rate of helium gas was maintained at 200 sccm, and a radio frequency plasma discharge was turned on to carry out plasma chemical vapor deposition on the surface of the substrate. The energy output mode of radio frequency was pulse, in which the pulse duty cycle was 50%, the pulse frequency was 300 Hz, the pulse discharge power was 250 W, and the reaction time was 3600 s.

After coating, compressed air was introduced to restore the chamber to normal pressure, and the coated substrate was taken out. The water contact angle and oil contact angle were tested, and the test results are listed in the following Table 1; and the double 85 test was conducted in a high temperature and high humidity environment, and the test results are shown in FIG. 1.

### Embodiment 3

A Si sheet serving as a substrate was placed on a substrate holder in a plasma chamber, the chamber was vacuumized to reach a pressure of 100 mTorr, helium gas was introduced at a flow rate of 150 sccm, and a temperature of the chamber was 55° C.

A pressure in the chamber was maintained at 100 mTorr, the flow rate of helium gas was maintained at 150 sccm, and a plasma continuous discharge was turned on to pretreat the substrate. The discharge power was 400 W, and the discharge duration time was 600 s.

Thereafter, a homogeneous solution was prepared by mixing 3M electronic fluorinated liquid 7200, monofunctional perfluoropolyether (methyl)acrylate (M_{w}≈1000, SuZhou Chemwells Advanced Materials CO., LTD), and p-hydroxyanisole at a weight ratio of 7:3:0.015, and then added into monomer tank 1. 1,6-Hexanediol diacrylate (HDDA) and p-hydroxyanisole were dissolved at a weight ratio of 1:0.005, and then added into monomer tank 2. The monomers in monomer tank 1 and monomer tank 2 were vaporized at a vaporization temperature of 110° C., and then the gas from monomer tank 1 was introduced into the plasma chamber at a flow rate of 285 μL/min and the gas from monomer tank 2 was introduced into the plasma chamber at a flow rate of 15 μL/min (i.e., the flow rate ratio was 9.5:0.5). The pressure in the chamber was maintained at 100 mTorr, the flow rate of helium gas was maintained at 150 sccm, and a radio frequency plasma discharge was turned on to carry out plasma chemical vapor deposition on the surface of the substrate. The energy output mode of radio frequency was pulse, in which the pulse duty cycle was 35%, the pulse frequency was 500 Hz, the pulse discharge power was 200 W, and the reaction time was 3600 s.

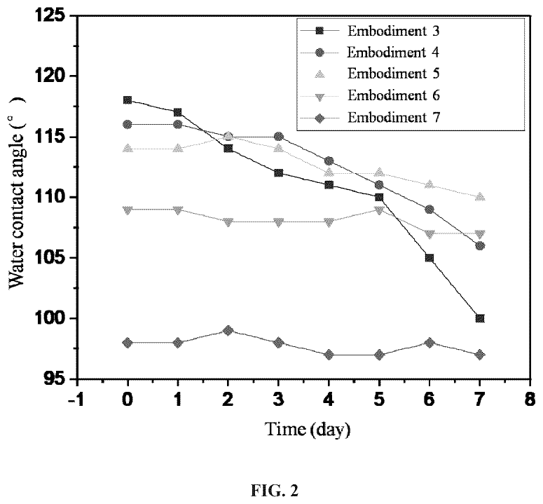

After coating, compressed air was introduced to restore the chamber to normal pressure, and the coated substrate was taken out. The water contact angle and oil contact angle were tested, and the test results are listed in the following Table 1; and the double 85 test was conducted in a high temperature and high humidity environment, and the test results are shown in FIG. 2.

### Embodiment 4

A Si sheet serving as a substrate was placed on a substrate holder in a plasma chamber, the chamber was vacuumized to reach a pressure of 100 mTorr, helium gas was introduced at a flow rate of 150 sccm, and a temperature of the chamber was 55° C.

A pressure in the chamber was maintained at 100 mTorr, the flow rate of helium gas was maintained at 150 sccm, and a plasma continuous discharge was turned on to pretreat the substrate. The discharge power was 400 W, and the discharge duration time was 600 s.

Thereafter, a homogeneous solution was prepared by mixing 3M electronic fluorinated liquid 7200, monofunctional perfluoropolyether (methyl)acrylate (M_{w}≈1000, SuZhou Chemwells Advanced Materials CO., LTD), and p-hydroxyanisole at a weight ratio of 7:3:0.015, and then added into monomer tank 1. 1,6-Hexanediol diacrylate (HDDA) and p-hydroxyanisole were dissolved at a weight ratio of 1:0.005, and then added into monomer tank 2. The monomers in monomer tank 1 and monomer tank 2 were vaporized at a vaporization temperature of 110° C., and then the gas from monomer tank 1 was introduced into the plasma chamber at a flow rate of 270 μL/min and the gas from monomer tank 2 was introduced into the plasma chamber at a flow rate of 30 μL/min (i.e., the flow rate ratio was 9.1). The pressure in the chamber was maintained at 100 mTorr, the flow rate of helium gas was maintained at 150 sccm, and a radio frequency plasma discharge was turned on to carry out plasma chemical vapor deposition on the surface of the substrate. The energy output mode of radio frequency was pulse, in which the pulse duty cycle was 35%, the pulse frequency was 500 Hz, the pulse discharge power was 200 W, and the reaction time was 3600 s.

After coating, compressed air was introduced to restore the chamber to normal pressure, and the coated substrate was taken out. The water contact angle and oil contact angle were tested, and the test results are listed in the following Table 1; and the double 85 test was conducted in a high temperature and high humidity environment, and the test results are shown in FIG. 2.

### Embodiment 5

A Si sheet serving as a substrate was placed on a substrate holder in a plasma chamber, the chamber was vacuumized to reach a pressure of 100 mTorr, helium gas was introduced at a flow rate of 150 sccm, and a temperature of the chamber was 55° C.

A pressure in the chamber was maintained at 100 mTorr, the flow rate of helium gas was maintained at 150 sccm, and a plasma continuous discharge was turned on to pretreat the substrate. The discharge power was 400 W, and the discharge duration time was 600 s.

Thereafter, a homogeneous solution was prepared by mixing 3M electronic fluorinated liquid 7200, monofunctional perfluoropolyether (methyl)acrylate (M_{w}≈1000, SuZhou Chemwells Advanced Materials CO., LTD), and p-hydroxyanisole at a weight ratio of 7:3:0.015, and then added into monomer tank 1. 1,6-Hexanediol diacrylate (HDDA) and p-hydroxyanisole were dissolved at a weight ratio of 1:0.005, and then added into monomer tank 2. The monomers in monomer tank 1 and monomer tank 2 were vaporized at a vaporization temperature of 110° C., and then the gas from monomer tank 1 was introduced into the plasma chamber at a flow rate of 210 μL/min and the gas from monomer tank 2 was introduced into the plasma chamber at a flow rate of 90 μL/min (i.e., the flow rate ratio was 7:3). The pressure in the chamber was maintained at 100 mTorr, the flow rate of helium gas was maintained at 150 sccm, and a radio frequency plasma discharge was turned on to carry out plasma chemical vapor deposition on the surface of the substrate. The energy output mode of radio frequency was pulse, in which the pulse duty cycle was 35%, the pulse frequency was 500 Hz, the pulse discharge power was 200 W, and the reaction time was 3600 s.

After coating, compressed air was introduced to restore the chamber to normal pressure, and the coated substrate was taken out. The water contact angle and oil contact angle were tested, and the test results are listed in the following Table 1; and the double 85 test was conducted in a high temperature and high humidity environment, and the test results are shown in FIG. 2.

### Embodiment 6

A Si sheet serving as a substrate was placed on a substrate holder in a plasma chamber, the chamber was vacuumized to reach a pressure of 100 mTorr, helium gas was introduced at a flow rate of 150 sccm, and a temperature of the chamber was 55° C.

A pressure in the chamber was maintained at 100 mTorr, the flow rate of helium gas was maintained at 150 sccm, and a plasma continuous discharge was turned on to pretreat the substrate. The discharge power was 400 W, and the discharge duration time was 600 s.

Thereafter, a homogeneous solution was prepared by mixing 3M electronic fluorinated liquid 7200, monofunctional perfluoropolyether (methyl)acrylate (M_{w}≈1000, SuZhou Chemwells Advanced Materials CO., LTD), and p-hydroxyanisole at a weight ratio of 7:3:0.015, and then added into monomer tank 1. 1,6-Hexanediol diacrylate (HDDA) and p-hydroxyanisole were dissolved at a weight ratio of 1:0.005, and then added into monomer tank 2. The monomers in monomer tank 1 and monomer tank 2 were vaporized at a vaporization temperature of 110° C., and then the gas from monomer tank 1 was introduced into the plasma chamber at a flow rate of 150 μL/min and the gas from monomer tank 2 was introduced into the plasma chamber at a flow rate of 150 μL/min (i.e., the flow rate ratio was 5:5). The pressure in the chamber was maintained at 100 mTorr, the flow rate of helium gas was maintained at 150 sccm, and a radio frequency plasma discharge was turned on to carry out plasma chemical vapor deposition on the surface of the substrate. The energy output mode of radio frequency was pulse, in which the pulse duty cycle was 35%, the pulse frequency was 500 Hz, the pulse discharge power was 200 W, and the reaction time was 3600 s.

After coating, compressed air was introduced to restore the chamber to normal pressure, and the coated substrate was taken out. The water contact angle and oil contact angle were tested, and the test results are listed in the following Table 1; and the double 85 test was conducted in a high temperature and high humidity environment, and the test results are shown in FIG. 2.

### Embodiment 7

A Si sheet serving as a substrate was placed on a substrate holder in a plasma chamber, the chamber was vacuumized to reach a pressure of 100 mTorr, helium gas was introduced at a flow rate of 150 sccm, and a temperature of the chamber was 55° C.

A pressure in the chamber was maintained at 100 mTorr, the flow rate of helium gas was maintained at 150 sccm, and a plasma continuous discharge was turned on to pretreat the substrate. The discharge power was 400 W, and the discharge duration time was 600 s.

Thereafter, a homogeneous solution was prepared by mixing 3M electronic fluorinated liquid 7200, monofunctional perfluoropolyether (methyl)acrylate (M_{w}≈1000, SuZhou Chemwells Advanced Materials CO., LTD), and p-hydroxyanisole at a weight ratio of 7:3:0.015, and then added into monomer tank 1. 1,6-Hexanediol diacrylate (HDDA) and p-hydroxyanisole were dissolved at a weight ratio of 1:0.005, and then added into monomer tank 2. The monomers in monomer tank 1 and monomer tank 2 were vaporized at a vaporization temperature of 110° C., and then the gas from monomer tank 1 was introduced into the plasma chamber at a flow rate of 90 μL/min and the gas from monomer tank 2 was introduced into the plasma chamber at a flow rate of 210 μL/min (i.e., the flow rate ratio was 3:7). The pressure in the chamber was maintained at 100 mTorr, the flow rate of helium gas was maintained at 150 sccm, and a radio frequency plasma discharge was turned on to carry out plasma chemical vapor deposition on the surface of the substrate. The energy output mode of radio frequency was pulse, in which the pulse duty cycle was 35%, the pulse frequency was 500 Hz, the pulse discharge power was 200 W, and the reaction time was 3600 s.

After coating, compressed air was introduced to restore the chamber to normal pressure, and the coated substrate was taken out. The water contact angle and oil contact angle were tested, and the test results are listed in the following Table 1; and the double 85 test was conducted in a high temperature and high humidity environment, and the test results are shown in FIG. 2.

TABLE 1
Test Results of the water contact angle and the oil contact angle

| | water contact | oil (n-hexadecane) |
|---|---|---|
| | angle/° | contact angle/° |
| Embodiment 1 | 115 | 72 |
| Embodiment 2 | 116 | 73 |
| Comparative Embodiment 1 | 118 | 75 |
| Embodiment 3 | 118 | 75 |
| Embodiment 4 | 116 | 74 |
| Embodiment 5 | 114 | 70 |
| Embodiment 6 | 109 | 66 |
| Embodiment 7 | 97 | 60 |

According to the test results in Table 1, the hydrophobic and oleophobic film layers in Embodiment 1, Embodiment 2, and Comparative Embodiment 1 have similar water contact angles and oil (n-hexadecane) contact angles. FIG. 1 illustrates a graph showing Double 85 Test results for Embodiment 1, Embodiment 2, and Comparative Embodiment 1. Referring to FIG. 1, in the double 85 test, the water contact angle of the film layer in Comparative Embodiment 1 significantly decreased starting from day 2, while the water contact angle of the film layers in Embodiment 1 and Embodiment 2 decreased slowly. Moreover, trimethylolpropane triacrylate (TMPTA) monomer with three double bonds was introduced to prepare the film layer in Embodiment 2, leading to a better hydrophobic stability compared to Embodiment 1 and Comparative Embodiment 1.

According to the test results in Table 1, for Embodiment 3 to Embodiment 7, the ratio of the flow rate of the gas from monomer tank 1 to the flow rate of the gas from monomer tank 2 changed from 9.5:0.5, to 9:1, to 7:3, to 5:5, to 3:7, and the water contact angle and oil contact angle of the film layer exhibited a decreasing trend with the increase of the ratio of the flow rate of the gas from monomer tank 2 to the flow rate of the gas from monomer tank 1. FIG. 2 illustrates a graph showing Double 85 Test results for Embodiment 3 to Embodiment 7. Referring to FIG. 2, as the ratio of the amount of monomer in monomer tank 1 to the amount of monomer in monomer tank 2 decreased, the hydrophobicity of the prepared film layer decreased (the water contact angles decreased), while the high hydrophobicity stability of the prepared film layer was improved as the water contact angles' decreasing rate became slower in the double 85 test.

The aforementioned descriptions are merely exemplary embodiments provided to illustrate the principles of the present disclosure and are not intended to limit its scope of protection. Any modifications and improvements that may be made by those skilled in the art without departing from the spirit and essence of the present disclosure shall also fall within the protection scope of the present disclosure.

1. A hydrophobic and oleophobic film layer, being a plasma polymerization coating formed by contacting a substrate with a plasma of a monomer α and a plasma of a monomer wherein the monomer α has a structure of formula (1), 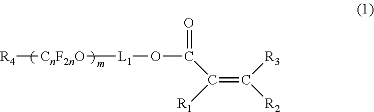
in formula (1), R₁, R₂ and R₃ are respectively and independently selected from a C₁-C₄ hydrocarbon group or a hydrogen atom; R₄ is selected from a C₁-C₄ perfluorinated alkyl group or a fluorine atom; and L₁ is a linking group; and
m is an integer greater than or equal to 1; each n in the m number of repeating units is respectively and independently selected from an integer greater than or equal to 1; and
wherein the monomer β contains two or more carbon-carbon unsaturated bonds.

2. The hydrophobic and oleophobic film layer according to claim 1, wherein the carbon-carbon unsaturated bond of the monomer β has a structure of formula (2), 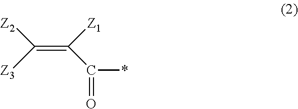
and in formula (2), Z₁, Z₂ and Z₃ are respectively and independently selected from a hydrogen atom or a C₁-C₄ alkyl group.

3. The hydrophobic and oleophobic film layer according to claim 2, wherein the monomer β has a structure of formula (3), 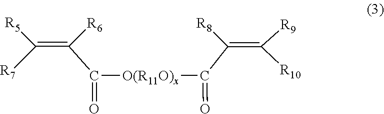
in formula (3), R₅, R₆, R₇, R₈, R₉, and R₁₀ are respectively and independently selected from a hydrogen atom or a C₁-C₄ alkyl group; R₁₁ is a C₂-C₁₀ alkylene group or a substituted C₂-C₁₀ alkylene group; and x is an integer ranging from 1 to 10; and
a substituent of the substituted C₂-C₁₀ alkylene group is a C₁-C₄ alkyl group or a C₁-C₄ hydroxyalkyl group.

4. The hydrophobic and oleophobic film layer according to claim 3, wherein the R₅, R₆, R₇, R₈, R₉, and R₁₀ are respectively and independently selected from a hydrogen atom or a methyl group.

5. The hydrophobic and oleophobic film layer according to claim 3, wherein the monomer β comprises at least one selected from a group consisting of: ethylene glycol dimethacrylate, ethylene glycol diacrylate, diethylene glycol dimethacrylate, diethylene glycol diacrylate, triethylene glycol dimethacrylate, triethylene glycol diacrylate, tetraethylene glycol dimethacrylate, tetraethylene glycol diacrylate, 1,3-butanediol dimethacrylate, 1,4-butanediol dimethacrylate, 1,4-butanediol diacrylate, neopentyl glycol dimethacrylate, neopentyl glycol diacrylate, 1,6-hexanediol dimethacrylate, 1,6-hexanediol diacrylate, polyethylene glycol dimethacrylate, polyethylene glycol diacrylate, polypropylene glycol dimethacrylate, polypropylene glycol diacrylate, 1,5-pentanediol diacrylate, dipropylene glycol diacrylate, and tripropylene glycol diacrylate.

6. The hydrophobic and oleophobic film layer according to claim 2, wherein the monomer β has a structure of formula (4), 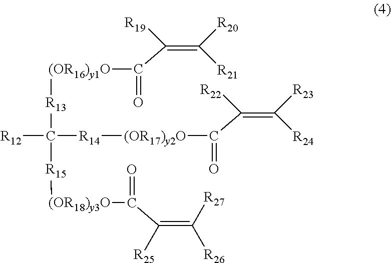
in formula (4), R₁₂ is a C₁-C₁₀ alkyl group or a hydroxyl-substituted C₁-C₁₀ alkyl group, R₁₃, R₁₄ and R₁₅ are respectively and independently selected from a C₁-C₁₀ alkylene group, R₁₆, R₁₇ and R₁₈ are respectively and independently selected from a C₂-C₁₀ alkylene group, R₁₉, R₂₀, R₂₁, R₂₂, R₂₃, R₂₄, R₂₅, R₂₆ and R₂₇ are respectively and independently selected from a hydrogen atom or a C₁-C₄ alkyl group, and y1, y2 and y3 are respectively and independently selected from an integer ranging from 0 to 10.

7. The hydrophobic and oleophobic film layer according to claim 6, wherein in formula (4), the R₁₂ is a C₁-C₄ alkyl group or a C₁-C₄ hydroxyalkyl group, the R₁₃, R₁₄ and R₁₅ are respectively and independently selected from a C₁-C₄ alkylene group, the R₁₆, R₁₇ and R₁₈ are respectively and independently selected from a C₂-C₄ alkylene group, the R₁₉, R₂₀, R₂₁, R₂₂, R₂₃, R₂₄, R₂₅, R₂₆ and R₂₇ are respectively and independently selected from a hydrogen atom or a methyl group, and the y1, y2 and y3 are respectively and independently selected from an integer ranging from 0 to 2.

8. The hydrophobic and oleophobic film layer according to claim 6, wherein the monomer β comprises at least one selected from a group consisting of: trimethylolpropane trimethacrylate, trimethylolpropane triacrylate, pentaerythritol triacrylate, ethoxylated trimethylolpropane triacrylate, and propoxylated trimethylolpropane triacrylate.

9. The hydrophobic and oleophobic film layer according to claim 1, wherein the monomer β comprises at least one selected from a group consisting of: pentaerythritol tetraacrylate, dipentaerythritol pentaacrylate, dipentaerythritol hexaacrylate, triallyl cyanurate, triallylamine, divinylbenzene, diethylene glycol divinyl ether, triethylene glycol divinyl ether, 1,4-butanediol divinyl ether, pentaerythritol triallyl ether, 2,6-dimethyl-2,4,6-octatriene, 1,2,4-trivinylcyclohexane, 1,4-cyclohexanedimethanol divinyl ether, diethylene glycol diacrylate, trimethylolpropane triacrylate, and 1,6-hexanediol diacrylate.

10. (canceled)

11. The hydrophobic and oleophobic film layer according to claim 1, wherein a molar ratio of the monomer α to the monomer β ranges from 0.5:9.5 to 9.5:0.5.

12. The hydrophobic and oleophobic film layer according to claim 11, wherein the molar ratio of the monomer α to the monomer β ranges from 5:5 to 9.5:0.5.

13. The hydrophobic and oleophobic film layer according to claim 1, wherein in formula (1), the R₁, R₂ and R₃ are respectively and independently selected from a methyl group or a hydrogen atom.

14. (canceled)

15. The hydrophobic and oleophobic film layer according to claim 1, wherein a weight-average molecular weight of the monomer α is greater than or equal to 1000.

16. The hydrophobic and oleophobic film layer according to claim 1, wherein in formula (1), the L₁ is selected from a substituted C₁-C₄ alkylene group or an unsubstituted C₁-C₄ alkylene group; and
a substituent of the substituted C₁-C₄ alkylene group comprises one or more selected from a group consisting of: alkyl, cycloalkyl, alkenyl, alkynyl, aryl, heteroaryl, heterocyclic group, carboxyl, carboxylate ion, carboxylate ester group, carbamate group, alkoxy, ketone group, aldehyde group, amine group, amide group, hydroxyl, nitrile group, nitroso group, and halogen.

17. (canceled)

18. The hydrophobic and oleophobic film layer according to claim 16, wherein in formula (1), the L₁ is a perfluorinated alkylene group.

19. The hydrophobic and oleophobic film layer according to claim 1, wherein the monomer α has a structure of formula (5), 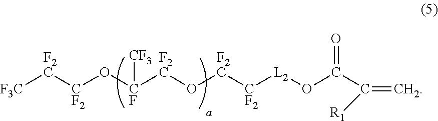
in formula (5), a is an integer greater than or equal to 1; and L₂ is selected from a connecting bond, a substituted methylene group or an unsubstituted methylene group, or a substituted ethylene group or an unsubstituted ethylene group; or
wherein the monomer α has a structure of formula (6), 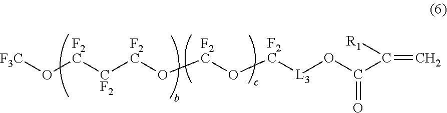
in formula (6), b is an integer greater than or equal to 1, c is an integer greater than or equal to 1, and L₃ is selected from a connecting bond, or a substituted C₁-C₃ alkylene group or an unsubstituted C₁-C₃ alkylene group; or
wherein the monomer α has a structure of formula (7), 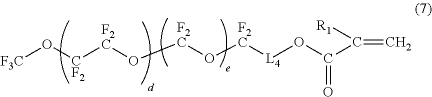
in formula (7), d is an integer greater than or equal to 1, e is an integer greater than or equal to 1, and L₄ is selected from a connecting bond, or a substituted C₁-C₃ alkylene group or an unsubstituted C₁-C₃ alkylene group; or
wherein the monomer α has a structure of formula (8), 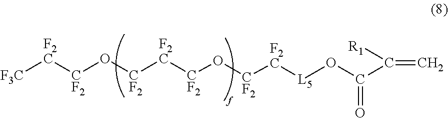
in formula (8), f is an integer greater than or equal to 1; and L₅ is selected from a connecting bond, a substituted methylene group or an unsubstituted methylene group, or a substituted ethylene group or an unsubstituted ethylene group.

20-22. (canceled)

23. The hydrophobic and oleophobic film layer according to claim 1, wherein a water contact angle of the hydrophobic and oleophobic film layer is greater than or equal to 95°, and an n-hexadecane contact angle of the hydrophobic and oleophobic film layer is greater than or equal to 60°; or
wherein a water contact angle of the hydrophobic and oleophobic film layer is greater than or equal to 108°, and an n-hexadecane contact angle of the hydrophobic and oleophobic film layer is greater than or equal to 65°.

24. (canceled)

25. A method for preparing the hydrophobic and oleophobic film layer according to claim 1, comprising:
placing a substrate in a plasma reaction chamber; and
vaporizing and then introducing the monomer α and the monomer β into the plasma reaction chamber, turning on a plasma discharge, and forming the hydrophobic and oleophobic film layer on a surface of the substrate from the plasma of monomer α and the plasma of monomer β through chemical vapor deposition.

26. The method according to claim 25, wherein vaporizing and then introducing the monomer α and the monomer β into the plasma reaction chamber comprises:
dissolving and then adding the monomer α, a fluorine-containing solvent and a polymerization inhibitor into a monomer tank 1, and adding the monomer β into a monomer tank 2; and
heating the monomer tank 1 and the monomer tank 2 to vaporize the monomer α and the monomer β and then introducing the monomer α and the monomer β into the plasma reaction chamber.

27-29. (canceled)

30. The method according to claim 26, wherein a mass ratio of the monomer α to the fluorine-containing solvent ranges from 1:9 to 9:1; and
the fluorine-containing solvent is a fluorocarbon solvent, and the fluorocarbon solvent comprises one or more selected from a group consisting of: methyl perfluorobutyl ether, ethyl perfluorobutyl ether, 3-methoxyperfluorohexane, perfluorobutyl ethyl propyl ether, perfluoropolyether oil, hexafluoropropylene oxide dimer, hexafluoropropylene oxide trimer, perfluorotriethylamine, perfluorotripropylamine, perfluorotributylamine, 3M electronic fluorinated liquid 7100, 3M electronic fluorinated liquid 7200, 3M electronic fluorinated liquid 7300, 3M electronic fluorinated liquid 7500, and 3M electronic fluorinated liquid 7700.

31. (canceled)

32. The method according to claim 26, wherein the polymerization inhibitor comprises one or more selected from a group consisting of: hydroquinone, p-benzoquinone, methyl hydroquinone, p-hydroxyanisole, 2-tert-butylhydroquinone, 2,5-di-tert-butylhydroquinone, and 2,6-di-tert-butyl-p-cresol.

33. The method according to claim 26, wherein the plasma discharge is a continuous discharge, a discharge power ranges from 10 W to 300 W, and a discharge duration time ranges from 60 s to 36000 s; or
wherein the plasma discharge is a pulse discharge, a discharge power ranges from 10 W to 400 W, a pulse duty cycle ranges from 0.1% to 80%, a pulse frequency ranges from 10 Hz to 500 Hz, and a discharge duration time ranges from 200 s to 36000 s.

34-36. (canceled)

37. A device, wherein at least a part of a surface of the device is provided with the hydrophobic and oleophobic film layer according to claim 1.
